(19) United States
(12) Patent Application Publication
(10) Pub. No.: US 2010/0180185 A1
(43) Pub. Date: Jul. 15, 2010

(54) SYSTEM AND METHOD APPENDING INTERNET COMMAND FUNCTIONS

(75) Inventor: David Joseph O'Hanlon, Miller Place, NY (US)

Correspondence Address: David Joseph O'Hanlon, 466 Miller Place Road, Miller Place, NY, 11764, US

(73) Assignee: David Joseph O'Hanlon, Miller Place, NY (US)

(21) Appl. No.: 12/352,602

(22) Filed: Jan. 12, 2009

(51) Int. Cl. G06F 17/00; G06F 3/048

(52) U.S. Cl. 715/205; 715/760

(57) ABSTRACT

A system and method of software database tracking system design encompasses user, commercial user, professional and novice researcher usage of the internet on database systems located locally on hard-drives or remotely on servers through internet protocol design computers and storage systems alike IP telephony, mobile phones, mobile system storage devices and average home computers to emulate small as well as large command demand files upon objects, through menus, or display directly on a location on a website to dedicate to the user's need and demand for a high-grade interoperability of usage on the internet both as point to point landing pages including objects as precisely offering step by step user's usage in a functioning internet environment including some cases of expertly delivering advertisements a unique database would calculate based upon the user of such a database tracking system while offered automatically in conjunction with selected user's use or subscribed upon their action to utilize the system as expertly set to calculate their desire based on usage for information such as advertisements, previously visited websites, dependent upon database created expert delivery in many forms.

### OBJECTS OF THE PRESENT INVENTION

An object is to provide a software and system that can be used easily. A further object is to provide a software and system that has an economically feasible manufacturing cost.

### BACKGROUND OF THE INVENTION

A newly defined computer software system and method is created to allow a beneficial access to the internet, interesting people and businesses alike, in content found on the internet, including the content dissemination to multiple party users, advertisers, and information gatherers, for education or monetary gain. A practical use of internet commands recorded to emulate a quick and final destination for the computer user. The computer user selects commands to access the internet after they subscribe or are freely provided to use the computer software program. They begin with the computer software program interface that will begin tracking their movements on the internet. As each progressive step of any type, albeit, but not limited to, search boxes, hyper-linking, and secure password and login names, for example, are utilized, the result is the recordation of the path used to find the final destination, resulting in a single image, that may be named by the participant, to cut down on the flow of steps to reach said internet destination. The ability to complete at least one dual command and actuation function is created. This would allow a user from going to “Internet Command A” first and then to “Internet Command B.” The result of the path recordation would be to go to “Internet Command B” without the use of landing “Internet Command A” first. This is done using the coding of an image on a desktop, aptly named by the consumer computer user. It may also be at least one image is placed in a separate format somewhere on the computer, within the software interface or on the first locale of visiting a webpage where they are stored or however a place, readily available, to still operate said computer software system. This practical use extends to sequential images as well. The computer user may choose from “Internet Command A” and go to “Internet Command B” and sequentially or by-stepping to “Internet Command X” one at a time until the final destination is achieved or the computer user is finished at any variable in between. Known as computer toolbar interfaces is one option, but not limited to, displaying each sequential image and the number of steps it will take to reach the destination by a computer user implementing a trail through the computer user interface. The computer user or commercial computer user may send or link through a network with friends, software community members, or within businesses the trails one creates. The commercial computer user can network, but is not limited to, providing through at least one database, a display of trails, including multiple choices, such as, trail variations or impressions of differently defined trails, to select the best content created for use by the consumer. The content created by the commercial computer user, includes, but is not limited to, the advertisement of routing to consumers through a network, trails, defined by the computer software system and method. Images for each computer may be interfaced with choices of personally designed or predetermined images acceptable to the consumer or commercial computer user. The computer software system and method can also be used for a set of predesigned website pages or created content utilizing the method to provide, but not limited to, tutorials, internet research workflow, or the use for presentations. A more radically simple design may be fixed type or hyperlink color, but is not limited to, the boxing and coloration for visibility by the consumer of the selection to satisfy following trails on the internet. It is also beneficial to enable cookie conversion, but is not limited to this parameter, for creating trails on the internet. The use of varying the actuation or more simply, mouse-clicks, go to commands, or hyper-linking of the computer commands alternately, by the selection of a sequential image having said actuation or personally on the content, by the consumer or commercial computer user may also be beneficial. More significantly, hyperlinked advertising indicia is presented on each image or one at a time on each sequentially presented image or becomes dependent on the internet alteration said image transforms thereon, but is not limited to, a toolbar or different interface for following trail steps. This includes the allowance for varied or fixed hyperlinked advertising for multiple exposures as each step of a trail is taken. The image may also include a type box for internet commands, such as, but is not limited to, internet searches, partial or end-result passwords and log-in names, or streaming current information. The trail image is also available to drag to the desktop to disseminate to other users through email and still operates thereby said computer software system method or said computer software system method encoded therein, rather than collecting only in the said computer software interface or storage place.

### DETAILED DESCRIPTION OF THE DRAWINGS

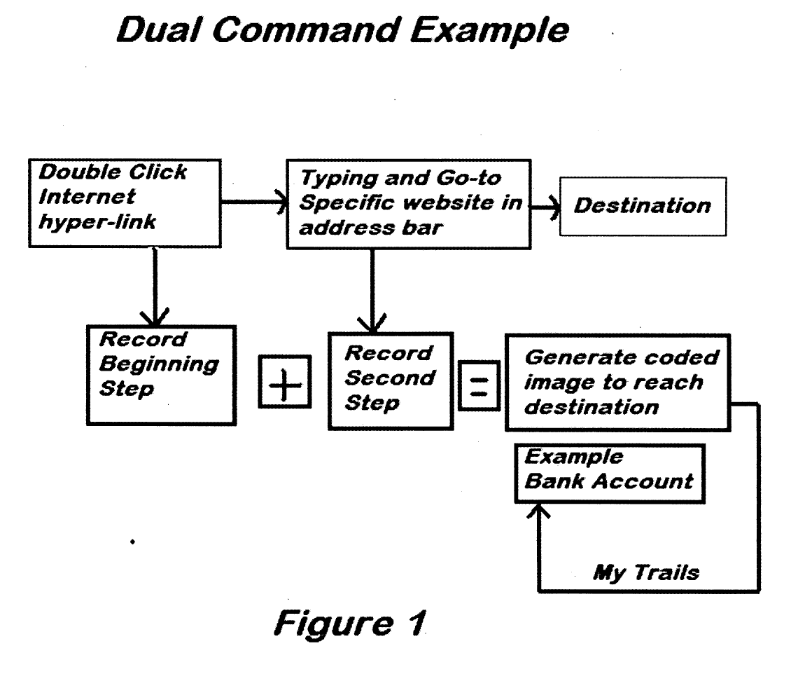

Drawing FIG. 1 shows a workflow diagram adding together at least one dual command function, recording it, and generating an image to go directly to the final destination with mouse-click.

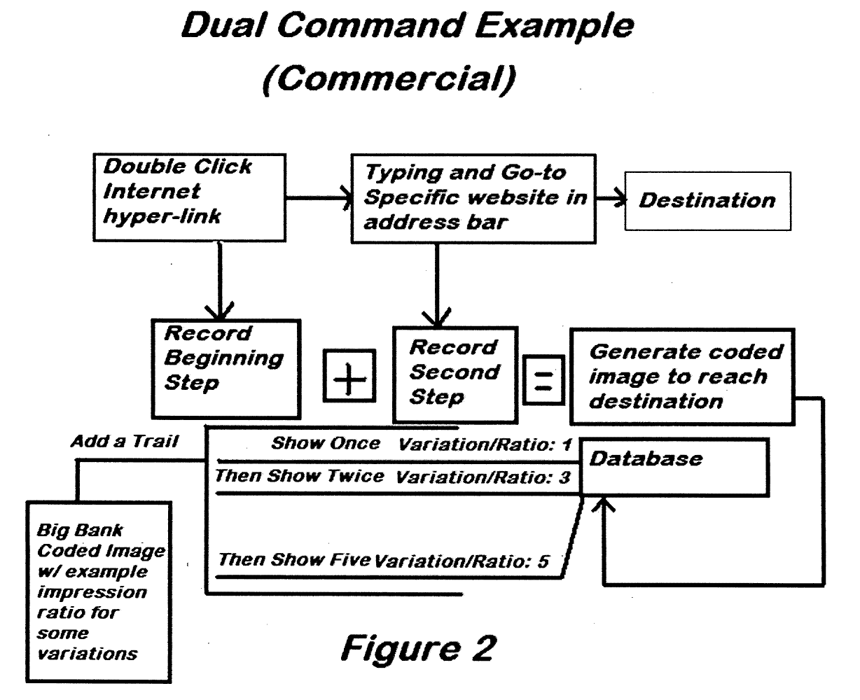

Drawing FIG. 2 continues a workflow diagram, as in Drawing FIG. 1, making calculations and redirection through a database, as an example trail impressions, being at least one of the calculations, used to produce better results for the commercial advertiser.

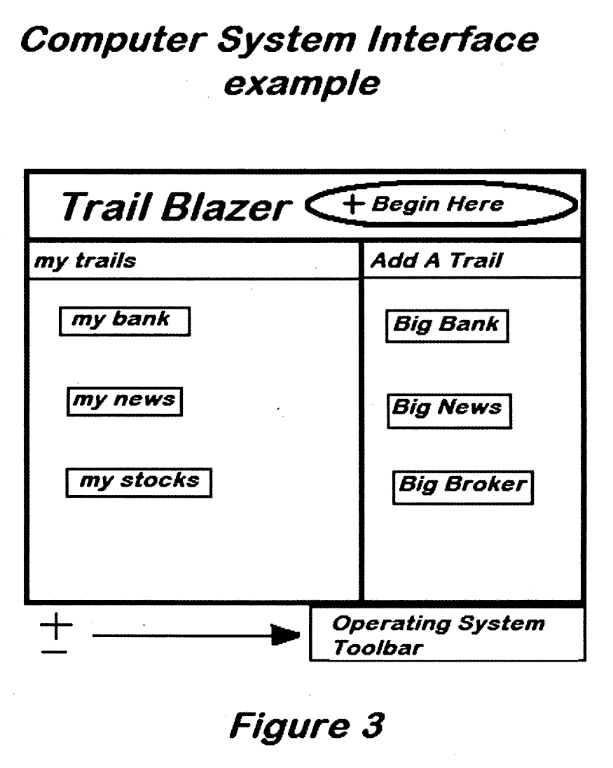

Drawing FIG. 3 shows a computer software interface. The computer user and commercial computer user has designed images to make at least one dual command function upon actuating the image with mouse-click.

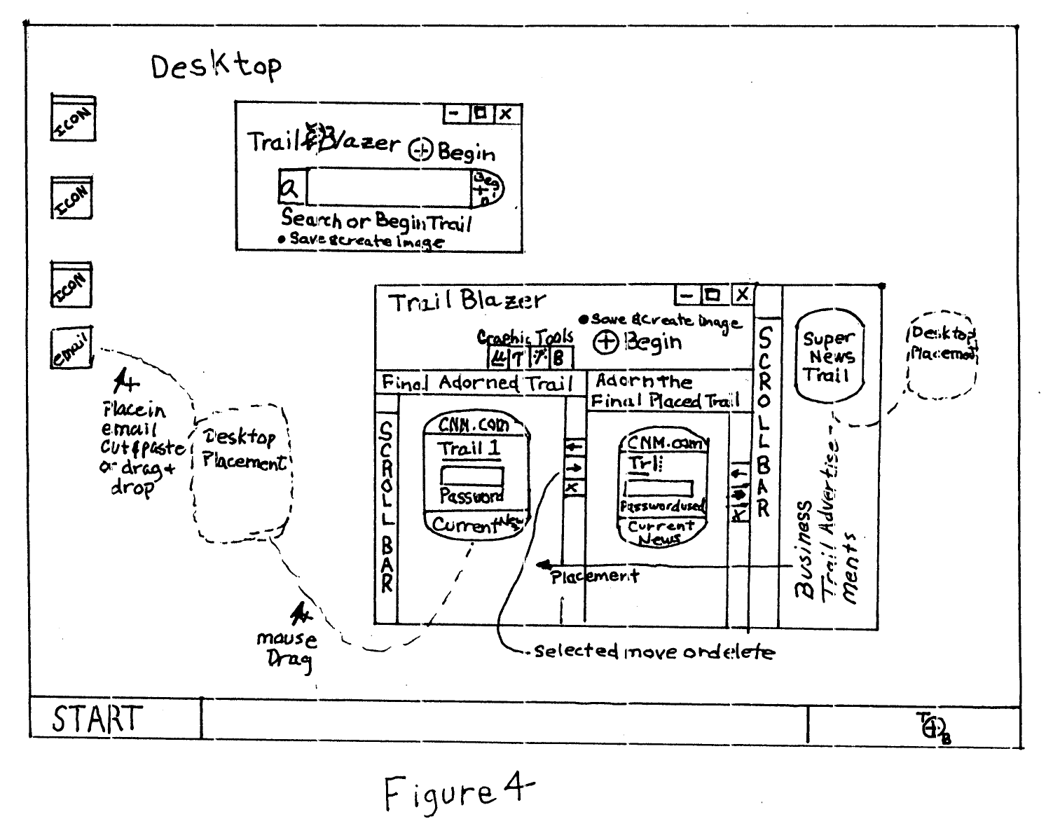

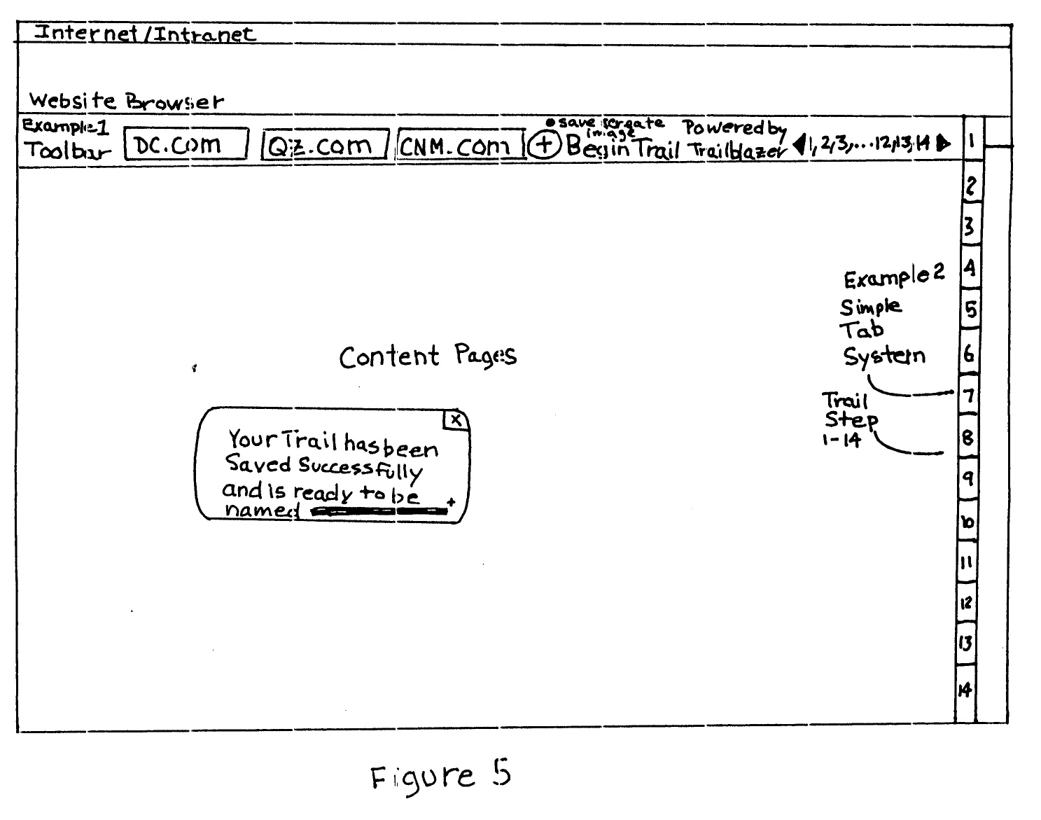

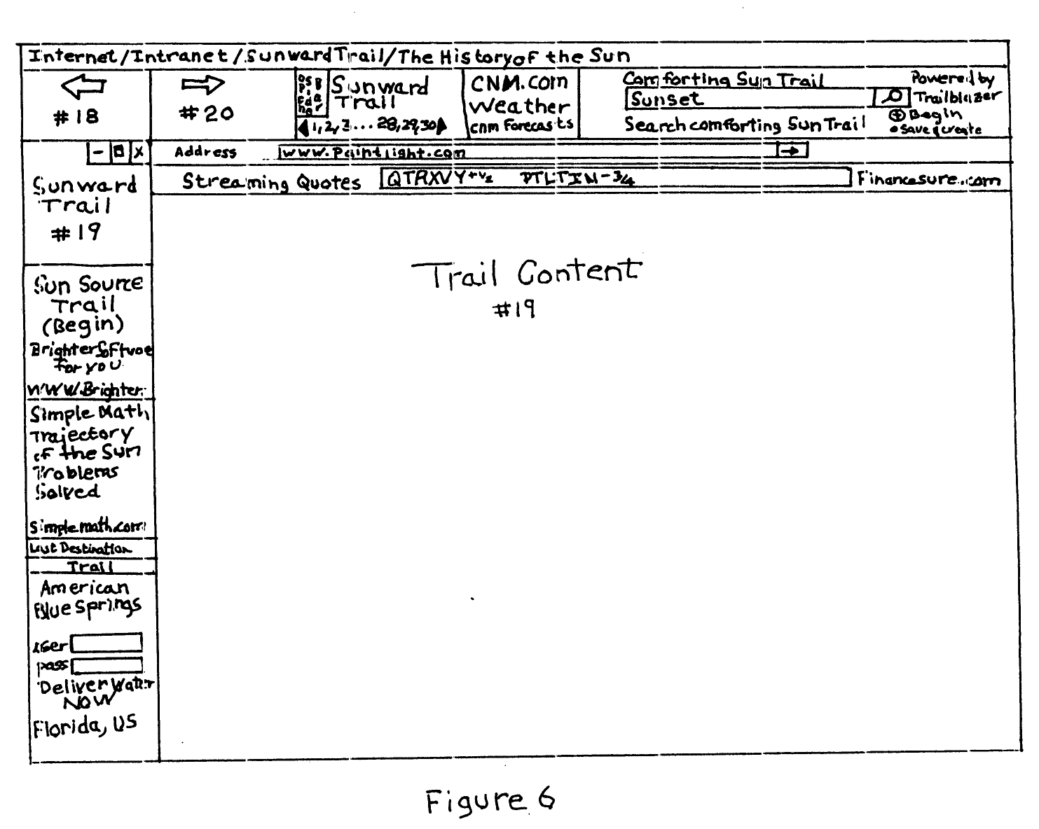

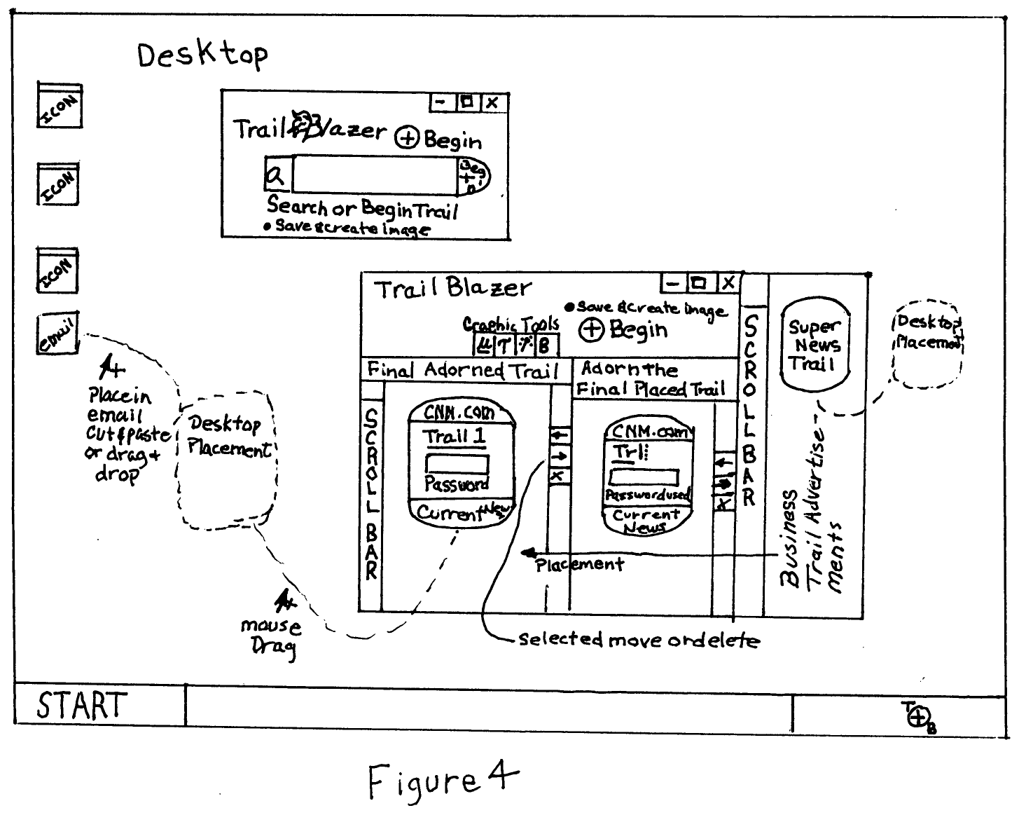

Drawing FIG. 4 shows a computer interface, toolbar type, begin point. An example of a computer interface for editing, creating, storing, and transferring trails is also shown. It also shows the automated advertising on computer user trails and the allowance for computer users to be creative with the trail icons.

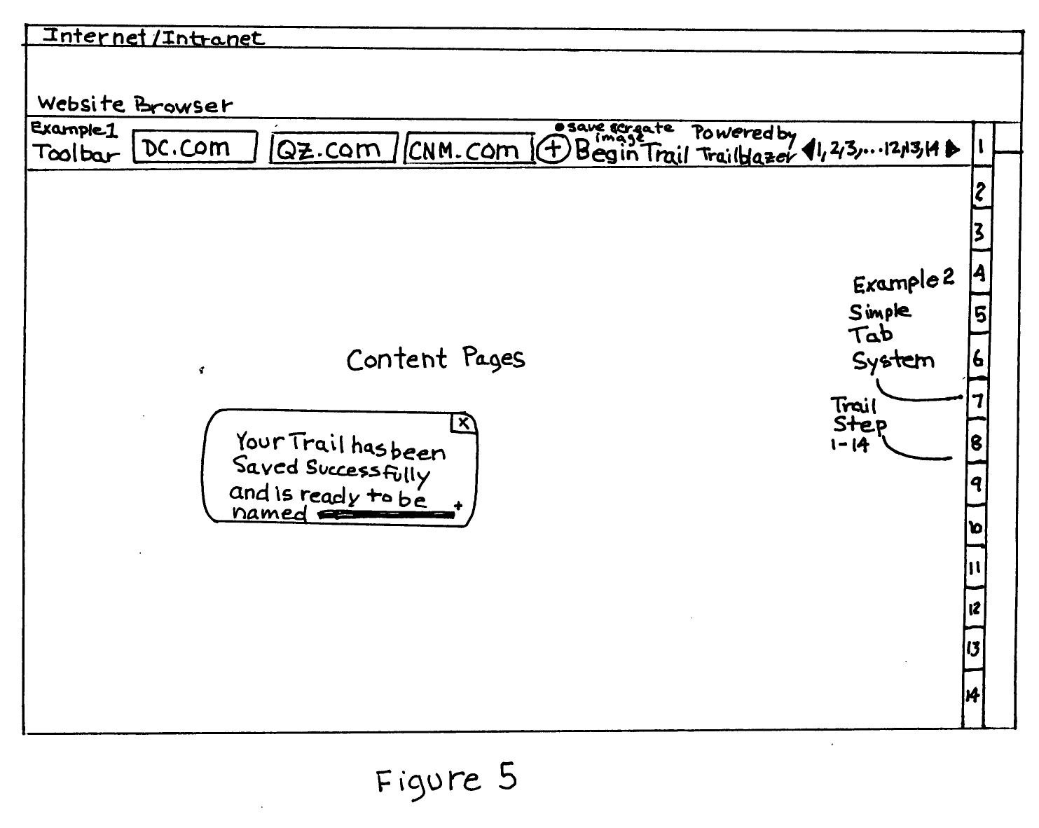

Drawing FIG. 5 shows a computer interface alternate on the internet, toolbar type with advertising, and simple tab example on the side bar.

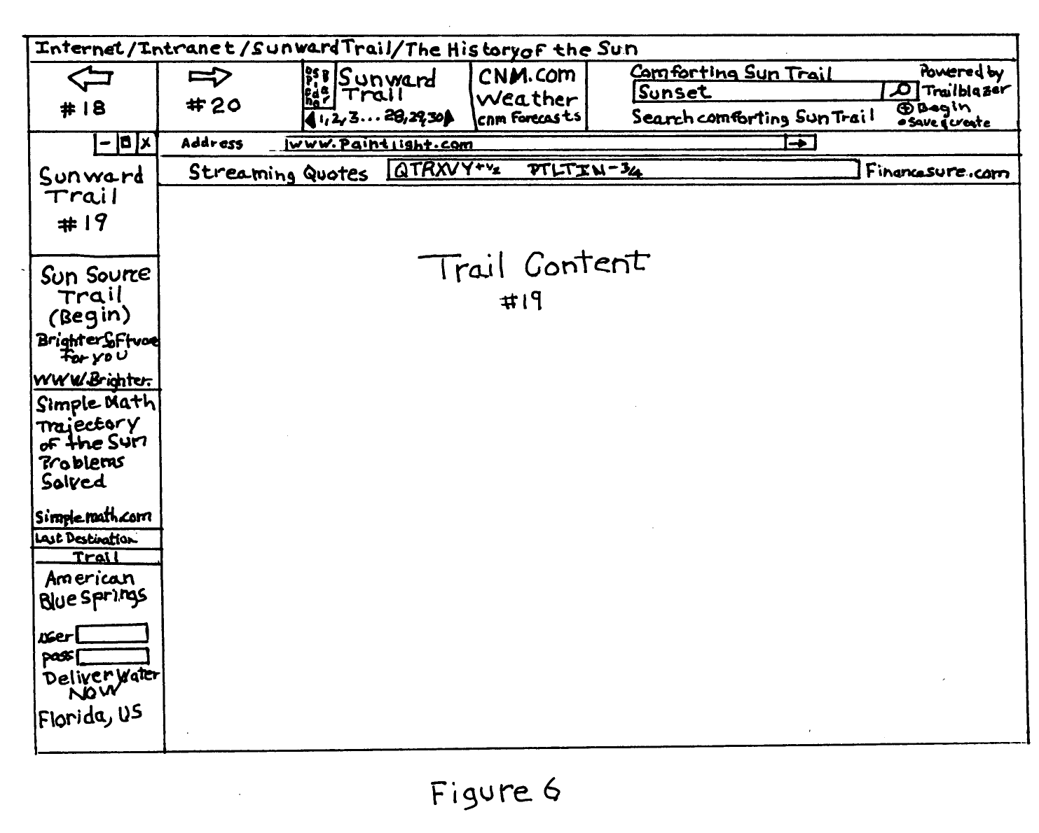

Drawing FIG. 6 shows a multi-interface, sophisticated, advertising and trail environment.

### DETAILED DESCRIPTION

The computer software has a number of respective mutually exclusive and at least some inclusive concepts part of the time as follows:

A computer software system, having command method comprising multiple internet commands appended thereto, wherein the following instructions are utilized:

A computer user selects first internet command function, accessing the internet; Said computer user selects the second internet hyper-linking command function, continuing to access internet further, said command function, appending command function I, logging pathway I and logging and actuating command thereon dependent function H, resulting dual command function, generated by computer software system; Said computer user selects another command, creating triple command and further commands or stops;

Wherein any number said internet command functions, including, but not limited to, hyper-linking, typed instructions, and go-to page commands, are recorded, through computer software system code and display therein said computer software system image interface, including, but not limited to, desktop or webpage said computer software system code image record result;

The computer software system wherein at least on dual internet command function is created;

The computer software system image interface wherein the recorded coded images are computer user organized categorically, edited, added, or deleted;

The computer software system wherein the computer user begins online;

The computer software system wherein internet access is direct using said computer software system website search type-box directly affecting access point;

The computer software system wherein said command function, includes, but not limited to, automated fill log-in and password commands;

The computer software system wherein said command functions are protected, including, but not limited to, secure sockets layer system;

The computer software system wherein at least one graphic tool, including but not limited to, a text-tool is used to label or adorn a predetermined coded image;

The computer software system wherein a predetermined or creative coded image constitutes user logged pathway and actuating commands;

A computer software system, having command method comprising multiple internet commands appended thereto, wherein the following instructions are utilized:

A commercial computer user selects first internet command function, accessing the internet;

Said commercial computer user selects the second internet hyper-linking command function, continuing to access internet further, said command function, appending command function I, logging pathway I, and logging and actuating command thereon dependent function II, resulting dual command function, generated by computer software system;

Said commercial computer user selects another command, creating triple command and further commands or stops; a generated coded image predetermined or created becomes database directed;

Said database displays named command function wherein said computer user chooses possible selection;

Wherein said computer software system displays, including, but not limited to, said database directly through said computer software system image interface through placing database data back through the internet said computer user personal location or accessible webpage;

The computer software system wherein at least one database record is created;

The computer software system wherein at least one recorded database entry results said computer user selection;

The computer software system wherein at least one recorded database entry results said computer user selection;

The computer software system wherein said database provides advertising categories;

The computer software system wherein said database provides said personal location or said accessible webpage impressions said commercial computer user created said coded image predetermined or created;

The computer software system wherein said database ranks first said commercial computer user relevancy said computer user selected created said coded image predetermined or created said result higher internet traffic;

The computer software system wherein said database allows one commercial user multiple variant impressions coding and said image;

The computer software system wherein said database allows one commercial user multiple variant impressions images and said coding;

The computer software system wherein said database records per impressions, actuations, said computer user so chooses;

A computer software system, having command method comprising multiple internet commands appended thereto, wherein the following instructions are utilized:

A commercial or consumer computer user selects first internet command function, accessing the internet;

Said commercial or consumer computer user selects the second internet hyper-linking command function, continuing to access internet further, said command function, appending command function I, logging pathway I, and logging and actuating command thereon dependent function H, resulting dual command function, generated by computer software system;

Said commercial or consumer computer user selects another command, creating triple command and further commands or stops;

A generated coded set of sequential images predetermined or created becomes said consumer computer user accessible or said commercial computer user database directed;

Said consumer user said accessible said sequential images display said command functions in unitary sequence format wherein said computer user chooses step 1 said sequential image displaying step 2 upon selection said step 1;

Or said commercial computer user said database directed said sequential images display said command functions in unitary sequence format wherein said commercial computer user sets onto said database network;

Wherein said computer software system displays, including, but not limited to, provide said accessible said unitary said sequential image said consumer user access within said computer interface, including, but not limited to, desktop or webpage said computer software system code image record result or said commercial computer said database directly through said computer software system image interface through placing sequential image data back through internet said commercial computer user said consumer computer user personal location or accessible webpage via said network, including, but not limited to, desktop or webpage said computer software system code image record result, including, at least one advertising indicia;

The computer software system wherein at least one dual interne command function said sequential image is created;

The computer software system wherein networks or email are used sharing images or said sequential images;

The computer software system wherein an image or sequential image is predetermined or personally created;

The computer software system wherein said database uses multiple trail images variations ranking;

The computer software system wherein said database can be searched, but not limited to, keywords wherein said keywords are within said content or title another trail;

The computer software system wherein a separate system graphic interface, including, but not limited to, computer system interface tool bars, desktop icons, website browsers, or most recent graphics displayed in any format, are used to begin tracking, also displaying upon said image or said sequential image, within said separate system graphic interface, step values, in part or whole, ability to toggle forward or backward, or said images or said sequential images, having said value or said values, wherein displayed separately, within said separate system graphic interface, are the pertaining number of steps taken or said ability to toggle forward or backward, including, advertising indicia thereon said separate system graphic interface;

The computer software system wherein pre-designed website pages or computer interface images provide trail destinations containing at least one common command thereto, pertaining, but not limited to, tutorials, research workflows or presentations;

The computer software system wherein type or hyperlink color, but not limited to, colored boxing these, are used to follow destined trails said computer user providing at least one said actuation command either alternately between said image or said sequential image or utilizing completely;

The computer software system wherein computer cookie information determines destination through actuation command instructions upon stored said cookie information said computer software system conversion;

The computer software system wherein at least one image or at least one said sequential image having at least one adorned hyper-link advertising indicia;

The computer software system wherein at least one image or said at least one sequential image derives at least one related separate graphic interface, such as, but not limited to, internet and desktop toolbars, menus, or open interfaces, transforming, during a transition from the desktop to the interne, wherein at least one image or said at least one sequential image or their predecessor, at least one related separate graphic interface, advertise hyper-linked indicia;

The computer software system wherein at least one image, at least one said sequential image, or at least one related separate graphic interface, such as, but not limited to, interne and desktop toolbars, menus, or open interfaces has adorned hyper-link advertising indicia, wherein said advertising indicia is varied or has fixed multiple advertising exposures during each trail step;

The computer software system wherein at least one image or said at least one sequential image, includes, at least one type box, but is not limited to, interne searches, partial trail or end-result trail passwords and log-in name actuations, or streaming current advertising indicia;

The computer software system wherein at least one image is also available to drag and drop out of, and operate thereon, but is not limited to, the desktop, email, or a system network, still operated thereby said computer software system method or operated by computer software system method encoded therein at least one image or at least one said sequential image;

The computer software system wherein multivariate database testing said at least one advertising indicia wherein desktop or separate graphic system interface displays said at least one advertising indicia, resolving economic demand, including but not limited to, multiple advertising formats;

The computer software system wherein at least one image or at least one sequential image is layered or said layer said image is encoded;

The computer software system wherein at least one image or said at least one sequential image potential path are selected having at least one criteria value within an organized database interface wherein at least one internet transfer said path delivers website expert component created advertising indicia therein said organized database interface wherein said advertising indicia appear thereon website content pages utilizing predetermined potential path embedded website code integrated by an expert owner said website;

A computer software system, having method comprising at least one internet command appended thereto record, wherein the following instructions are utilized:

An automated at least one criteria value within an organized database interface sets data tracking system selection before, during, or after computer user internet use;

The computer user selects at least one website;

A predetermined or personally created record results;

Wherein at least one said internet command function, including, but not limited to, hyper-linking, typed instructions, and go-to page commands, are recorded, through computer software system code and display therein said computer software system image interface, including, but not limited to, desktop window and menus, website browser and menus, toolbar and menus, or webpage contents window said computer software system predetermined or created code image record result or more simplified produced list;

The computer software system wherein computer cookie information, including various other data tracking systems, but not limited to this parameter, automatically determines destination through actuation command instructions therein stored said cookie or said data tracking system information wherein at least one criteria value within an organized database interface sets said computer software system conversion at least one record image, at least one sequential image or at least one within simplified produced lists;

The computer software system wherein a computer user organizes, adds, edits, or deletes at least one image record, at least one sequential image or at least one within produced list wherein automated at least one criteria value within an organized database interface implementation is completed;

The computer software system wherein at least one image or said at least one sequential image or said at least one produced list potential path are selected having at least one criteria value within an organized database interface wherein at least one internet transfer said path delivers website expert component created advertising indicia therein said organized database interface wherein said advertising indicia appear thereon website content pages utilizing predetermined potential path embedded website code integrated by an expert website owner or affiliate;

The computer software system wherein automated data tracking simplified form said system code image, having at least one tracking record result, wherein organized, automated, at least one criteria value within an organized database interface, producing lists through user participation, displaying unique menus, including but not limited to, a mouse menu, or pull down menu therein computer software system interface wherein said menu use results advantageous computer usage said at least one record image, at least one sequential image, or said at least one within simplified produced lists;

The computer software system wherein a computer user saves at least one website wherein automated at least one criteria value, such as, computer saving within an organized database interface is set wherein record said website creates said at least one recorded image, said at least one sequential image or said at least one simplified produced list;

The computer software system wherein a computer user visits a website wherein automated at least one criteria value within an organized database interface is set wherein record most visited website is created said at least one recorded image or said at least one simplified produced list;

The computer software system wherein a computer user menu is opened wherein automated at least one criteria value within an organized database interface is set wherein record desktop window or website window is created said at least one recorded image or said at least one simplified produced list;

The computer software system wherein a computer user opens at least one desktop window or at least one website window wherein at least one criteria value within an organized database interface is set wherein multiple windows can be opened at one time wherein at least one record image, at least one sequential record image or at least one within simplified produced list opens at least one window;

The computer software system wherein a computer user opens at least one desktop window or at least one website window wherein at least one criteria value within an organized database interface is set wherein before, during, or after at least one record image, at least one sequential record image or at least one within simplified produced list recalls at least one closed window;

The computer software system wherein said computer software system, having at least one active at least one user notation, allots said user's usage benefit or transfer at least one other participant said notation benefiting other's user's usage;

The computer software system wherein said computer software system, having at least one notation automatically exhibited or part at least one user's usage thereon.

I claim:

1. A computer software system, having command method comprising multiple internet commands appended thereto, wherein the following instructions are utilized:
I) a computer user selects first internet command function, accessing the internet;
II) said computer user selects the second internet hyper-linking command function, continuing to access internet further, said command function, appending command function I, logging pathway I and logging and actuating command thereon dependent function II, resulting dual command function, generated by computer software system;
III.) said computer user selects another command, creating triple command and further commands or stops;
wherein any number said internet command functions, including, but not limited to, hyper-linking, typed instructions, and go-to page commands, are recorded, through computer software system code and display therein said computer software system image interface, including, but not limited to, desktop or webpage said computer software system code image record result.

2. The computer software system as in claim 1 wherein at least on dual internet command function is created.

3. The computer software system as in claim 1 wherein at least on image interface is created.

4. The computer software system image interface as in claim 1 wherein the recorded coded images are computer user organized categorically, edited, added, or deleted.

5. The computer software system as in claim 1 wherein the computer user begins online.

6. The computer software system as in claim 1 wherein internet access is direct using said computer software system website search type-box directly affecting access point.

7. The computer software system as in claim 1 wherein said command function, includes, but not limited to, automated fill log-in and password commands.

8. The computer software system as in claim 1 wherein said command functions are protected, including, but not limited to, secure sockets layer system.

9. The computer software system as in claim 1 wherein at least one graphic tool, including but not limited to, a text-tool is used to label or adorn a predetermined coded image.

10. The computer software system in claim 1 wherein a predetermined or creative coded image constitutes user logged pathway and actuating commands.

11. A computer software system, having command method comprising multiple internet commands appended thereto, wherein the following instructions are utilized:
I.) a commercial computer user selects first internet command function, accessing the internet;
II.) said commercial computer user selects the second internet hyper-linking command function, continuing to access internet further, said command function, appending command function I, logging pathway I, and logging and actuating command thereon dependent function II, resulting dual command function, generated by computer software system;
III.) said commercial computer user selects another command, creating triple command and further commands or stops; a generated coded image predetermined or created becomes database directed;
IV.) said database displays named command function wherein said computer user chooses possible selection;
wherein said computer software system displays, including, but not limited to, said database directly through said computer software system image interface through placing database data back through the interne said computer user personal location or accessible webpage.

12. The computer software system as in claim 11 wherein at least one database record is created.

13. The computer software system as in claim 11 wherein at least one recorded database entry results said computer user selection.

14. The computer software system as in claim 11 wherein at least one recorded database entry results said computer user selection.

15. The computer software system as in claim 11 wherein said database provides advertising categories.

16. The computer software system as in claim 11 wherein said database provides said personal location or said accessible webpage impressions said commercial computer user created said coded image predetermined or created.

17. The computer software system as in claim 11 wherein said database ranks first said commercial computer user relevancy said computer user selected created said coded image predetermined or created said result higher internet traffic.

18. The computer software system as in claim 11 wherein said database allows one commercial user multiple variant impressions coding and said image.

19. The computer software system as in claim 11 wherein said database allows one commercial user multiple variant impressions images and said coding;

20. The computer software system as in claim 11 wherein said database records per impressions, actuations, said computer user so chooses.

21-48. (canceled)

49. A computer software system, having command method comprising multiple internet commands appended thereto, wherein the following instructions are utilized:
(I) A commercial or consumer computer user selects first internet command function, accessing the internet;
(II) Said commercial or consumer computer user selects the second internet hyper-linking command function, continuing to access internet further, said command function, appending command function I, logging pathway I, and logging and actuating command thereon dependent function II, resulting dual command function, generated by computer software system;
(III) Said commercial or consumer computer user selects another command, creating triple command and further commands or stops;
(IV) A generated coded set of sequential images predetermined or created becomes said consumer computer user accessible or said commercial computer user database directed;
(V) Said consumer user said accessible said sequential images display said command functions in unitary sequence format wherein said computer user chooses step 1 said sequential image displaying step 2 upon selection said step 1;
(VI) Or said commercial computer user said database directed said sequential images display said command functions in unitary sequence format wherein said commercial computer user sets onto said database network;
Wherein said computer software system displays, including, but not limited to, provide said accessible said unitary said sequential image said consumer user access within said computer interface, including, but not limited to, desktop or webpage said computer software system code image record result or said commercial computer said database directly through said computer software system image interface through placing sequential image data back through internet said commercial computer user said consumer computer user personal location or accessible webpage via said network, including, but not limited to, desktop or webpage said computer software system code image record result, including, at least one advertising indicia.

50. The computer software system as in claim 49 wherein at least one dual interne command function said sequential image is created.

51. The computer software system as in claim 49 wherein networks or email are used sharing images or said sequential images.

52. The computer software system as in claim 49 wherein an image or sequential image is predetermined or personally created.

53. The computer software system as in claim 49 wherein said database uses multiple trail images variations ranking.

54. The computer software system as in claim 49 wherein said database can be searched, but not limited to, keywords wherein said keywords are within said content or title another trail.

55. The computer software system as in claim 49 wherein separate system graphic interface, including, but not limited to, computer system interface tool bars, desktop icons, website browsers, or most recent graphics displayed in any format, are used to begin tracking, also displaying upon said image or said sequential image, within said separate system graphic interface, step values, in part or whole, ability to toggle forward or backward, or said images or said sequential images, having said value or said values, wherein displayed separately, within said separate system graphic interface, are the pertaining number of steps taken or said ability to toggle forward or backward, including, advertising indicia thereon said separate system graphic interface.

56. The computer software system as in claim 49 wherein pre-designed website pages or computer interface images provide trail destinations containing at least one common command thereto, pertaining, but not limited to, tutorials, research workflows or presentations.

57. The computer software system as in claim 49 wherein type or hyperlink color, but not limited to, colored boxing these, are used to follow destined trails said computer user providing at least one said actuation command either alternately between said image or said sequential image or utilizing completely.

58. The computer software system as in claim 49 wherein computer cookie information determines destination through actuation command instructions upon stored said cookie information said computer software system conversion.

59. The computer software system as in claim 49 wherein at least one image or at least one said sequential image having at least one adorned hyper-link advertising indicia.

60. The computer software system as in claim 49 wherein at least one image or said at least one sequential image derives at least one related separate graphic interface, such as, but not limited to, internet and desktop toolbars, menus, or open interfaces, transforming, during a transition from the desktop to the internet, wherein at least one image or said at least one sequential image or their predecessor, at least one related separate graphic interface, advertise hyper-linked indicia.

61. The computer software system as in claim 49 wherein at least one image, at least one said sequential image, or at least one related separate graphic interface, such as, but not limited to, internet and desktop toolbars, menus, or open interfaces has adorned hyper-link advertising indicia, wherein said advertising indicia is varied or has fixed multiple advertising exposures during each trail step.

62. The computer software system as in claim 49 wherein at least one image or said at least one sequential image, includes, at least one type box, but is not limited to, internet searches, partial trail or end-result trail passwords and log-in name actuations, or streaming current advertising indicia.

61. The computer software system as in claim 49 wherein at least one image is also available to drag and drop out of, and operate thereon, but is not limited to, the desktop, email, or a system network, still operated thereby said computer software system method or operated by computer software system method encoded therein at least one image or at least one said sequential image.

62. The computer software system as in claim 49 wherein multivariate database testing said at least one advertising indicia wherein desktop or separate graphic system interface displays said at least one advertising indicia, resolving economic demand, including but not limited to, multiple advertising formats.

63. The computer software system as in claim 49 wherein at least one image or at least one sequential image is layered or said layer said image is encoded.

64. The computer software system as in claim 49 wherein at least one image or said at least one sequential image potential path are selected having at least one criteria value within an organized database interface wherein at least one internet transfer said path delivers website expert component created advertising indicia therein said organized database interface wherein said advertising indicia appear thereon website content pages utilizing predetermined potential path embedded website code integrated by an expert owner said website.

65. A computer software system, having method comprising at least one internet command appended thereto record, wherein the following instructions are utilized:
(I) An automated at least one criteria value within an organized database interface sets data tracking system selection before, during, or after computer user internet use;
(II) The computer user selects at least one website;
(III) A predetermined or personally created record results;
Wherein at least one said internet command function, including, but not limited to, hyper-linking, typed instructions, and go-to page commands, are recorded, through computer software system code and display therein said computer software system image interface, including, but not limited to, desktop window and menus, website browser and menus, toolbar and menus, or webpage contents window said computer software system predetermined or created code image record result or more simplified produced list.

66. The computer software system as in claim 65 wherein computer cookie information, including various other data tracking systems, but not limited to this parameter, automatically determines destination through actuation command instructions therein stored said cookie or said data tracking system information wherein at least one criteria value within an organized database interface sets said computer software system conversion at least one record image, at least one sequential image or at least one within simplified produced lists.

67. The computer software system as in claim 65 wherein a computer user organizes, adds, edits, or deletes at least one image record, at least one sequential image or at least one within produced list wherein automated at least one criteria value within an organized database interface implementation is completed.

68. The computer software system as in claim 65 wherein at least one image or said at least one sequential image or said at least one produced list potential path are selected having at least one criteria value within an organized database interface wherein at least one internet transfer said path delivers website expert component created advertising indicia therein said organized database interface wherein said advertising indicia appear thereon website content pages utilizing predetermined potential path embedded website code integrated by an expert website owner or affiliate.

69. The computer software system as in claim 65 wherein automated data tracking simplified form said system code image, having at least one tracking record result, wherein organized, automated, at least one criteria value within an organized database interface, producing lists through user participation, displaying unique menus, including but not limited to, a mouse menu, or pull down menu therein computer software system interface wherein said menu use results advantageous computer usage said at least one record image, at least one sequential image, or said at least one within simplified produced lists.

70. The computer software system as in claim 65 wherein a computer user saves at least one website wherein automated at least one criteria value, such as, computer saving within an organized database interface is set wherein record said website creates said at least one recorded image, said at least one sequential image or said at least one simplified produced list.

71. The computer software system as in claim 65 wherein a computer user visits a website wherein automated at least one criteria value within an organized database interface is set wherein record most visited website is created said at least one recorded image or said at least one simplified produced list.

72. The computer software system as in claim 65 wherein a computer user menu is opened wherein automated at least one criteria value within an organized database interface is set wherein record desktop window or website window is created said at least one recorded image or said at least one simplified produced list.

73. The computer software system as in claim 65 wherein a computer user opens at least one desktop window or at least one website window wherein at least one criteria value within an organized database interface is set wherein multiple windows can be opened at one time wherein at least one record image, at least one sequential record image or at least one within simplified produced list opens at least one window.

74. The computer software system as in claim 65 wherein a computer user opens at least one desktop window or at least one website window wherein at least one criteria value within an organized database interface is set wherein before, during, or after at least one record image, at least one sequential record image or at least one within simplified produced list recalls at least one closed window.

75. The computer software system as in claim 1 wherein said computer software system, having at least one active at least one user notation, allots said user's usage benefit or transfer at least one other participant said notation benefiting other's user's usage.

76. The computer software system as in claim 39 wherein said computer software system, having at least one notation automatically exhibited or part at least one user's usage thereon.
